(19) United States
(12) Patent Application Publication
(10) Pub. No.: US 2004/0035949 A1
(43) Pub. Date: Feb. 26, 2004

(54) Insect control system and method

(75) Inventors: Randall C. Elkins, Houston, TX (US); Jeffrey B. Tucker, Houston, TX (US)

Correspondence Address: Timothy M. Donoughue, 2400 Bank One Center, 910 Travis Street, Houston, TX, 77002, US

(73) Assignee: Coastal Mosquito Control LLC, Houston, TX (US)

(21) Appl. No.: 10/217,079

(22) Filed: Aug. 12, 2002

(51) Int. Cl. A01G 27/00

(52) U.S. Cl. 239/70; 239/69; 239/332

(57) ABSTRACT

A system and method for eradicating flying insects via a timed, self-agitating spraying system. A plurality of nozzles is placed throughout a location, attached to reservoir and a pumping unit. The pumping unit uses a motor, a pump, a control panel, and several valves and switches in order to function. The control panel controls the operation of the system so as to activate them in sequence that causes the recirculation of liquid in the reservoir prior to spraying. In this way, the reservoir contents are fully mixed prior to distribution.

### TECHNICAL FIELD

The instant invention relates in general to a system and method for eradicating mosquitoes, gnats, no-see-ums, flies, and other unpleasant insects via a fixed, timed spraying system. More specifically, the instant invention is a system and method of placing a plurality of nozzles throughout a location. The nozzles are attached to a pumping unit comprising a motor, a pump, a control panel, and several valves and switches. The control panel controls the operation of the motor, the pump, and the switches and valves so as to activate them in sequence at certain timed intervals. The system further comprises a reservoir from which insecticide is pumped by the motor and pump and into which, depending upon the settings of the valves and switches, insecticide is returned or sprayed into the distribution area. The intake and return of insecticide by the system creates a mixing function within the reservoir.

Users and service providers may utilize the instant invention to suppress various flying insects via the timed distribution of insecticide through the nozzles. A method is also disclosed which facilitates the eradication of other undesired insects.

### BACKGROUND

Air dispersion of insecticide for the control of biting and annoying insects is well-known in the art. Various air dispersion models are prevalent. Insecticides are sprayed from trucks, aircraft and cans with some regularity. Unfortunately, due to prevailing winds and the molecular nature of the atmosphere, the insecticides disperse to such a degree that they become ineffective after a relatively short period of time.

It is also known in the art to utilize a fixed system for the control of such insects in industrial and farm settings. Specifically, it is known in the art to control flies in barns where horses or cows are present through the placement of nozzles at various locations throughout the barn. A motor is used to pump insecticide from a reservoir to the several nozzles through piping. A timer controls the activation of the motor such that the insecticide is sprayed periodically, effectively eliminating flying insects from the area.

It is further known in the art to use insecticides that do not require agitation prior to dispersion. However, several of the more effective insecticides comprise colloidal suspensions (emulsifications, microcapsules, suspended solids, etc.) or other materials that require agitation to form a well-mixed disbursed material prior to distribution for maximum efficiency. Few systems, such as the Dramm AutoFog system, perform such agitation manually via a mechanical mixer. Such systems, however, suffer from a multitude of moving parts, each of which is subject to friction and maintenance problems.

There is a need in the art for a fixed insecticide distribution system and method that will effectively control insects using insecticides that require agitation prior to dispersion. There is further a need in the art for systems that are simpler, and thus cheaper to manufacture, maintain and service. Further, there is a need for a system that provides a high degree of mixing to colloidal suspension insecticides. The instant invention meets all of these needs and additionally several needs heretofore unseen in the art.

### DESCRIPTION OF THE DRAWINGS

FIG. 1 is a block diagram that depicts the mechanical and fluid flow routings of the instant invention.

FIG. 2 is a detail mechanical diagram view of the bottom of the intake pipe within the instant invention.

FIG. 3 is a flow chart drawing made in accordance with ANSI/ISO specification 5807-1985 depicting the overall operation of the instant invention.

FIG. 4 is an electrical schematic drawing depicting the general electrical design of the instant invention.

FIG. 5 is a mechanical diagram depicting the physical layout of the timer in one embodiment of the instant invention.

FIG. 6 is a schematic fluid flow diagram of the instant invention.

### DETAILED DESCRIPTION

In the following description, numerous specific details are set forth such as flow path, pump types, aerators, valve types, timers, etc., to provide a thorough understanding of the invention to the reader. However, it will be obvious to those skilled in the art that the present invention may be practiced without such specific details and, in fact, the present embodiments described herein may be modified in many details, all falling within the teaching of this disclosure and the attached claims. In other instances, well-known systems, valves, pumps, gauges, nozzles and control units have been shown in block diagram form in order to not obscure the present invention and unnecessary detail. For the most part, details concerning timing considerations, specific parts used, specific timers used, specific conduits used, and specific programmings and the like, have been omitted in as much as these details are not necessary to obtain a complete understanding of the present invention. Moreover, these details are well within the skills of persons of ordinary skill in the art.

It should be understood that in the context of this disclosure, a “motor” is a reference to a broad class of devices that generate mechanical, rotational energy. It should be understood by the reader that while the term “motor” will certainly include an electrical motor, it may, in certain embodiments, include an internal combustion engine, a wind driven device, a thermal driven device, or any other mechanical device which produces a rotational force.

Similarly, a “valve” is considered broadly to be a device that regulates the flow of a fluid. It will be appreciated by the reader that a valve may be activated by any number of means, including mechanically, electrically, pneumatically, or otherwise. It will also be appreciated that some valves perform particular functions, such as maintaining constant fluid velocities, maintaining constant fluid pressures and so forth. Each of these is considered a “valve” in the instant disclosure.

The term “switch” is further used broadly to represent a device that regulates the flow of electricity through a conductor. It will be appreciated that though many switches are mechanical, there are also electrical (semiconductor) switches and other switches that are regulated by other means. It will further be appreciated that a switch may have functions in addition to simply regulating the flow of electricity, such as timing (which may be related to the switching functions) or other functions that are unrelated to the electrical flow regulation. A switch may be quite complex, controlling the flow of electricity to more than one destination from more than one source, or, equally, a simple single-pole toggle switch. The term “switch” is used in this application is used in its broadest sense to incorporate all such switches.

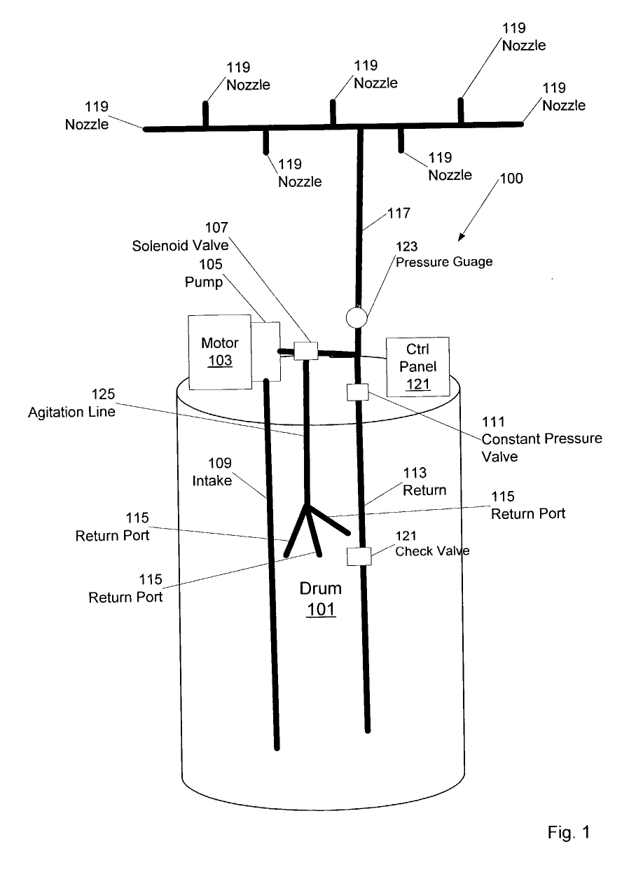

The details of the instant invention are described with reference to FIG. 1. FIG. 1 depicts an insect control system 100 comprising a drum 101 containing an insecticide or a liquid with insecticide-like properties which is to be mixed before application for maximum efficiency. While this application refers to an “insecticide,” which term typically incorporates substances which kill insects, for the purposes of this application, that term is to include substances which repel insects or otherwise dissuade insects from occupying any certain area.

While the size of the drum 101 may vary to fit into certain locations or for certain applications, a standard 55 gallon drum is used in a preferred embodiment, primarily due to its availability and size. However, smaller drums may be used equally which might provide lighter weights for some applications.

Fixably attached to the drum 101 is a motor 103. “Fixably attached”, as used in this application, includes any number of means already well-known in the art, including without limitation, riveting, bolting, screwing, welding, or applying an adhesive in order to hold one piece to another. Although the motor 103 is depicted as attached to the top lid of the drum 101, it will be appreciated by those skilled in the art that other embodiments may attach to motor 103 to another portion of the drum 101, such as the side of the drum. Alternatively, the motor 103 could be placed within the drum 101, fixably attached near or to the top lid of the drum 101.

The rotating spindle of the motor 103 is in mechanical connection with the spindle of a pump 105. The spindle of the motor 103 may be fixably attached to the spindle of the pump 105 or, in an alternative embodiment, may be attached through use of a less-fixed connection, such as a clutch mechanism (not shown). The housing of the pump 105 may be fixably connected to the housing of the motor 103 and/or the drum 101 such that the pump 105 remains fixed relative to the motor 103 and such that the spindle of the motor 103 activates the pump 105. It will be appreciated that the motor 103 and the pump 105 may, together, be referred to as a pump assembly.

The inlet of the pump 105 is connected to and in fluid communication with an intake hose 109 which is routed within the drum 101. The intake hose 109 may be affixed to the pump 105 by any variety of means well-appreciated within the art, including without limitation, a friction hose connection, a threaded connection, a quick-release connection and a screw type banded connection. All references to an affixed, fluid-communication connection in this application refer to a similar type of connection. All references in this application to the affixing or attachment of hoses, pipes or conduits similarly incorporate all means of attachment well-appreciated within the art. The length of the intake hose 109 will vary according to the depth of the drum 101 but, in the preferred embodiment, the intake hose 109 will reach to the bottom of the drum 101 so that when the level of insecticide in the drum 101 is low, it may still enter the intake hose 109.

The discharge side of the pump 105 is connected to and in fluid communication with a solenoid valve 107. Although FIG. 1 suggests some piping structure between the pump 105 and the solenoid valve 107, the solenoid valve 107 may be attached directly to the pump without such a hose or pipe so long as fluid communication is maintained. The solenoid valve 107 has two positions to select two different discharge routes. The first route is connected to and in fluid communication with an agitation line 125, which leads into the drum 101. The agitation line 125 may be of any length suitable for the function of returning fluid to the drum 101. The agitation line 125 has at its end a plurality of return ports 115. While the agitation line 125 is routed back into the drum 101, the return ports 115 are positioned within the drum 101 so as to return insecticide to the drum 101 in an agitating fashion. Although three return ports 115 are depicted on FIG. 1, those skilled in the art will readily appreciate that any number of return ports 115, including a single return port 115, could be used to return insecticide to the drum 101. It will further be appreciated that the return ports 115 may be nozzles or other discharge means (including a simple open discharge). However, in the preferred embodiment, multiple return nozzles 115 are utilized in order to optimally cause agitation of the insecticide drum 101.

The second discharge route from the solenoid valve 107 leads to a constant pressure valve 111 and a pressure gauge 123. It will be appreciated that the solenoid valve 107, the constant pressure valve 111 and the pressure gauge 123 may be fixably attached to the drum 101 for stability. Alternatively, the solenoid valve 107 may be fixably attached to the housing of the pump 105, and the constant pressure valve 111 and the pressure gauge 123 may each be fixably attached to the solenoid valve 107 to provide stability. Braces may be used between the components, as well, if additional stability is required. As with the fluid connection shown between the pump 105 and the solenoid valve 107, the fluid communication between the solenoid valve 107 and the constant pressure valve 111 may be piped or hosed as shown in FIG. 1. Likewise, the fluid communication between the solenoid valve 107 and the pressure gauge 123 may be piped or hosed. Those skilled in the art will appreciate that the fluid communication between the three components (the solenoid valve 107, the constant pressure valve 111 and the pressure gauge 123) may be obtained through the use of a T-connector or through the use of a solenoid valve 107 having two outlets for a single discharge position. Likewise, either the constant pressure valve 111 or the pressure gauge 123 may be designed to permit the connection of an additional component in fluid communication with their inlet sides.

The constant pressure valve 111 is connected to and in fluid communication with a return hose 113. The return hose 113 leads into the drum 101 to effect the return of insecticide to the drum 101.

Interposed along the return hose 113 is a check valve 121. The check valve 121 is affixed to and in fluid communication with the return hose 113. The function of the check valve 121 is that which is commonly appreciated in the art, namely to permit the flow of fluid only one direction along the return hose 113. The check valve 121 is positioned within or interposed on the return hose 113 so as to permit the flow of fluid in only in the upward direction toward the drum 101. Though the check valve 121 is shown medial to the return hose 113, it will be appreciated that the check valve 121 may be placed anywhere in the flow path of the return hose 113, including attached at the top or the bottom of the return hose 113.

The constant pressure valve 111 functions to maintain a constant pressure of insecticide liquid from the pump 105. Accordingly, and in the manner well appreciated within the valve art, constant pressure valve 111 will open more as the pressure generated by pump 105 increases. Therefore, as more pressure is generated by the pump 105, more fluid is returned to the drum 101 via the return hose 113. Pressure within the system may be measured at the pressure gauge 123. In this way, the constant pressure valve 111 insures a constant operating pressure for the insect control system 100. Also, the constant pressure valve 111 ensures that the pump 105 and the motor 103 are not over-pressurized and burned out. It will be appreciated that the constant pressure valve 111 may provide for a fixed, unadjustable pressure or may provide a constant pressure that is definable by the user, typically through means of the rotation of a knob on the constant pressure valve 111.

The pressure gauge 123 permits a user to view the pressure generated by the pump 105 and maintained by the constant pressure valve 111. However, those skilled in the art will appreciate that the pressure gauge 123 does not affect the operation of the pump 105 nor the insect control system 100 and is merely an added convenience within an embodiment of the invention. Therefore, the pressure gauge 123 may be omitted without effecting the functionality of the insect control system 100. If included, the pressure gauge 123 may be fixably attached to the drum 101 for additional stability.

The pressure gauge 123 (or, if omitted, the solenoid valve 107) is attached to and in fluid communication with a distribution hose 117 which is, in turn, in fluid communication with and attached to a plurality of nozzles 119. The nozzles 119 are positioned throughout the area in which the insects are to be controlled. Though nozzles are referred to, any means of creating an aerosol from the liquid may be used. Although a certain routing and configuration of the distribution hose 117 and the nozzles 119 seems to be suggested by FIG. 1, such configuration is merely for purposes of illustration and is not suggestive of any particular placement of the nozzles 119 or routing of the distribution hose 117. Those skilled in the art will appreciate that the nozzles 119 and the distribution hose 117 may be routed in any number of manners without affecting the operation of the insect control system 100. Also, although a plurality of nozzles 119 is demonstrated on FIG. 1, those skilled in the art will appreciate that a single nozzle 119 or many more nozzles 119 could be used with the instant invention.

The solenoid valve may be fixably attached to the drum 101 for stability. The solenoid valve 107 may default to the closed position so as to disallow the flow of fluid into the distribution hose 117, and thus the nozzles 119. When the solenoid valve 107 is activated, fluid is permitted into the distribution hose 117 and thus to the nozzles 119.

Although the solenoid valve 107 is, in this embodiment expressed, an electrical solenoid valve, those skilled in the art will appreciate that many different types of solenoid valves may be used in the instant application of an insect control system 100 and in the manner described on FIG. 1. For example, a pneumatically-activated valve may be used, if air pressure or vacuum is available or can be made so in a cost-effective manner.

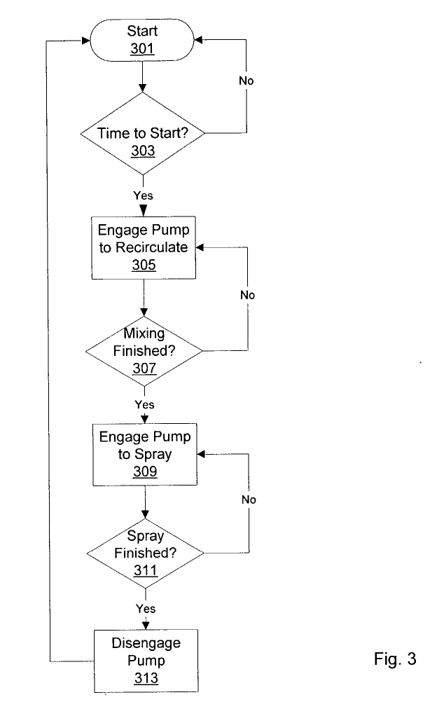

The insect control system 100 further includes a control panel 121 which is electrically connected to the motor 103 and the solenoid valve 107. Although in a preferred embodiment the control panel 121 is fixably attached to the drum 101 in close proximity to the motor 103 and the solenoid valve 107, it will be appreciated by those skilled in the art that the control panel 121 could be relocated to within the drum 101 at the top, on the side on the outside of the drum 101, or remotely from the drum all without affecting the operation of the insect control system 100 described herein. The control panel 101 functions to activate the motor 103 and the solenoid valve 107 at prescribed time periods so as to permit the proper operation of the system. The methodology by which the control panel 121 operates is described later herein with reference to FIG. 3.

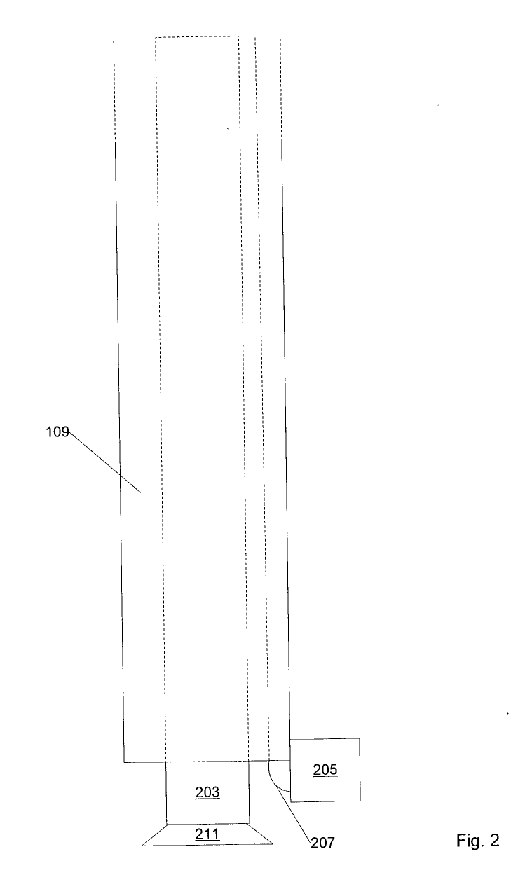

FIG. 2 demonstrates a close-up view of the intake hose 109 from FIG. 1. The intake hose 109 is an exterior tube having within it an interior tube 103 which actually conducts the flow of fluid from the drum (FIG. 1, 101) to the pump (FIG. 1, 105). The interior tube 103 is in fluid communication with a filter 211 which is affixed to the bottom opening of the interior tube 203. The filter 211 serves to remove debris from the flow of fluid entering the interior tube 203 so that damage is prevented to the insect control system, particularly the pump and nozzle elements of the system. The intake tube 109 also has attached thereto a fluid level switch 205. The precise placement of the fluid level switch 205 on the intake tube 109 is not critical to the operation of the invention, however, the fluid level switch 205 must be placed higher on the intake tube 109 than the intake provided at the filter 211. In this way, when the level of insecticide in the drum drops below the fluid level switch 205, the fluid level switch 205 is activated prior to the level of the fluid dropping below the intake afforded by the filter 211. The fluid level switch 205 is in electrical communication with the control panel (121 on FIG. 1) via a wire 207 that runs inside the intake pipe 109. The control panel is programmed to disengage and stop pumping activities if the fluid level switch 205 indicates that the level of the insecticide fluid has dropped below the level of the fluid level switch 205. According, it is also desirable for the fluid level switch 205 to be located as low on the intake pipe 109 as possible.

The methodology employed by the control panel (121 on FIG. 1) is shown with reference to FIG. 3. Although FIG. 3 sets forth certain details of the operation of the control panel, it will be well-appreciated by those skilled in the art that variations of the exact operation of the control panel may be made without affecting the operation of the insect control system. Indeed, steps with reference to FIG. 3 may be added, modified, or reordered so as to accomplish the same ends of mixing the fluid prior to spraying using the equipment and system described.

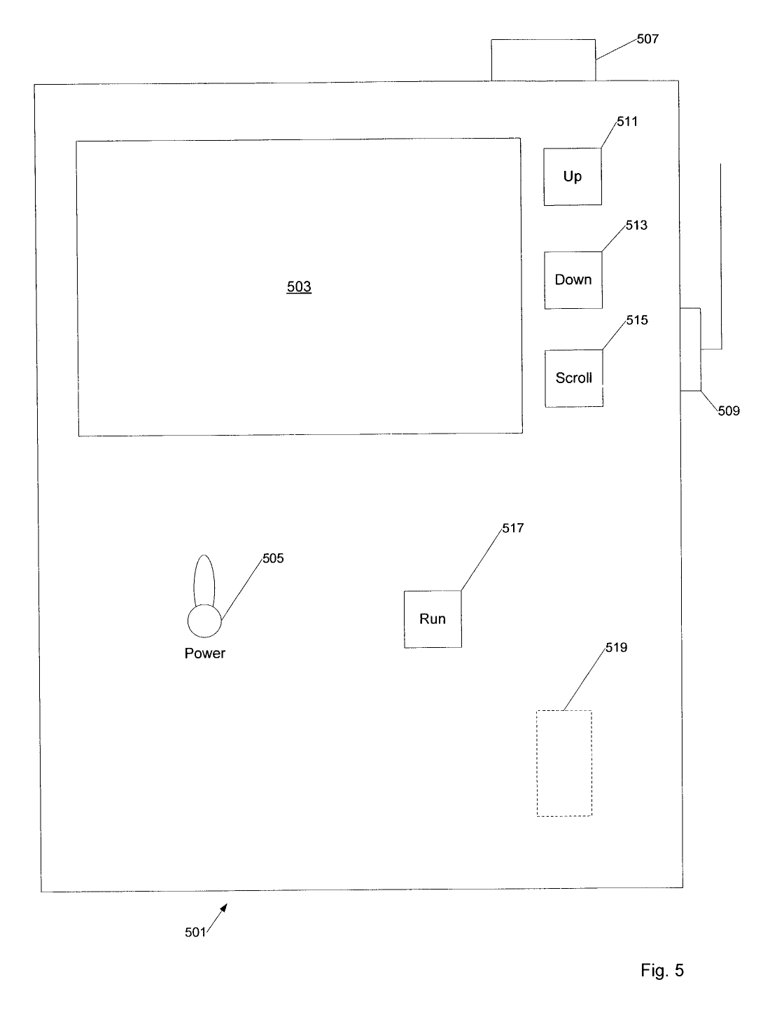

The operation of the control panel starts 301 with the precondition of an operation of a clock or timer so as to measure the passage of time. Additionally, a precondition at start 301 is that the fluid level switch (205 in FIG. 2) indicates a sufficient level of insecticide to permit the proper operation of the system. If this precondition is not met, the control panel may signal the user in the manner described later herein with reference to FIG. 5.

The control panel evaluates whether it is time to start a run of the process 303. The time to start a run of the process may be indicated by any number of means, including the expiration of a certain period of time from the prior run, by a manual signal from the user, or by the matching of the current time to a scheduled run time stored by the control panel. If the time on the timer is not equal to the start time, execution returns to the start 301 until such time occurs, at which point the control panel engages the motor attached to the pump 305. A closed default condition of the solenoid valve (FIG. 1, 107) causes the engagement of the pump to recirculate the fluid insecticide up the intake tube (109 on FIG. 1) and, ultimately down the agitation line (125 on FIG. 1). The control panel evaluates whether the recirculation mixing time is complete 307. If not, the pump continues to be engaged 305 and to recirculate the insecticide. Those skilled in the art will appreciate that the recirculation time will vary based upon the insecticide used, the size of the drum and the precise features of the embodiment of the invention. When mixing is complete, the control panel activates spraying 309. Spraying may be accomplished by continuing to activate the motor (and thus the pump) while activating the solenoid valve (107 on FIG. 1). Spray continues until the time for spraying has expired 311, at which point the pump and motor are disengaged 313. Operation of the control panel then returns to the start state 301.

Referring again to FIG. 1, the operation of the control panel 121 previously described is made with reference to a solenoid valve 107 which is, by default, maintained in the closed position, directing fluid down the agitation line 125. However, it will be well-appreciated by those skilled in the art that the solenoid valve 107 could be of the type that is, by default, maintained in the open position, directed toward the constant pressure valve 111 and the pressure gauge 123 (and ultimately the nozzles 119). In such a case, the operation of the control panel 121 would be altered to energize the solenoid valve 107 in order to accomplish a mixing function, and to de-energize the solenoid valve 107 in order to accomplish a spraying function.

It will further be appreciated by those skilled in the art that another embodiment of the invention would be to replace the solenoid valve 107 with a second motor similar to the motor 101. However, such an embodiment would involve additional motor costs, and programming of the control panel 121 or additional parts would be required to ensure that spraying did not occur while recirculation was occurring.

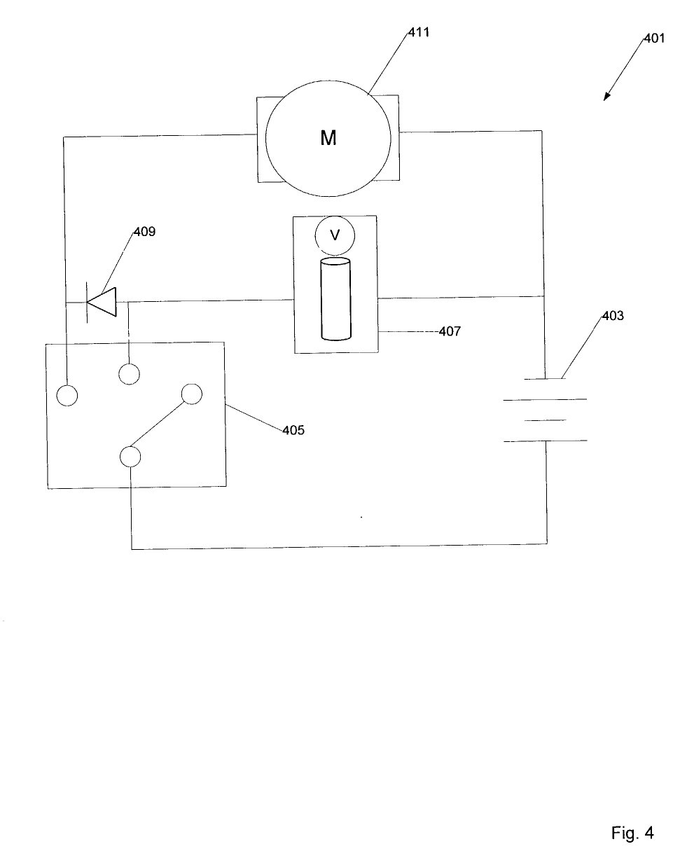

FIG. 4 depicts a schematic drawing of the electrical system 401 within the insect control system. The electrical system 401 comprises a power source 403 suitable for operating the motor 411 and the solenoid valve 407. The power source 403 in the preferred embodiment is a household current (in the United States, 120 volts alternating current at 60 Hz), those skilled in the art will appreciate that the power source 403 could be battery-based or solar-based if the system is placed in a remote area. Similarly, other power sources (wind, nuclear, etc.) could be used for the power source 403, all falling within the scope of the invention.

The power source 403 is electrically connected to a switch 405 that defaults to an off position. Although in one embodiment of the invention the switch 405 is an electro-mechanical switch featuring a timer coupled (e.g. connected mechanically and/or electrically so as to function as described) with the physical switch, a preferred embodiment features a computerized switch comprising a timing function. The switch 405 may step down the voltage of the power source 403 in order to operate a clock or computer-like components for the operation of the timer switch 405. The timer switch 405 has, in addition to the default off position, at least two additional positions.

In the first position (depicted at the far left) the switch permits electricity to flow up through the motor 411, thus completing the circuit. The solenoid valve 407 remains deenergized and in the closed position. In this first position of the timer switch 405, the system recirculates insecticide to the drum.

In the second position (depicted in the middle), current is permitted to flow through an energized solenoid valve 407 in order to move in to an open position. Current is also permitted to flow through a dielectric, such as a diode 409 so that the motor 411 also is energized. In this position, the system permits the spray of insecticide from the nozzles.

Those skilled in the art will appreciate that this schematic represents only the most basic of operation of the circuit. Additional components such as resistors and transformers may be required for the proper operation of the electrical system 401, depending upon the nature and type of the power source 403, the timer 405, the solenoid valve 407 and the motor 411. It will also be noted that, in an alternative embodiment where the default position of the solenoid valve 407 is the opposite of that described, the operations effected by the first and second switch positions described would be reversed.

Additionally, it will be appreciated by those skilled in the art that many, if not all of the components of the electrical system 401 are available commercially. For example, timers available for irrigation systems or similar timed-systems may be suitable for adaptation to the instant invention. However, several or all of the components may be customed designed. A particular component which may be well-suited to custom design is the timer 405.

The control panel of an embodiment of the insect control system is demonstrated with reference to FIG. 5. FIG. 5 depicts the control panel 501 having thereon a display screen 503 for communicating with the user of the system. The display screen 503 may show the status of the system (whether it is idle, recirculating, or spraying), the current time, the programmed spraying times, the recirculation time, and the like. The display screen 503 may also display service alerts, such as notifying the user that the level of the insecticide is too low, as indicated by the fluid level switch (FIG. 2 at 205). The display screen 503 may be a liquid crystal display (LCD), or, in alternative embodiments, any other manner of display technology well appreciated within the art. The display screen 503 may be lighted to permit communication with the user at night.

The control panel 501 also comprises a power switch 505 which is operable to permit the user to turn the system on and off. The control panel 504 further may feature a connection port 507 to facilitate the connection of the control panel 501 to the remainder of the system (e.g., the motor, solenoid valve, and power source). It will be appreciated by those skilled in the art that the connector 507 may be a removable connector, of the types commonly known within the art, or it may be a hard-wired connection such that the control panel 504 is permanently affixed to the other components of the system.

The control panel 501 may feature several control buttons, 511, 513, 515, 517. In one embodiment, three buttons, 511, 513, 515 are placed to the right of the display screen 503. The three buttons permit the user to communicate to the control panel to move the cursor to a different parameter field on the display screen 503 using a scroll button 515. Once the scroll button 515 has been used to select a certain parameter, that parameter may be adjusted up using the up button 511 or down using the down button 513.

The control panel 501 may also feature a run button 517, which functions to immediately begin a cycle of the system (as described previously with reference to FIG. 3) without regard to the time or the next scheduled cycle. The control panel 501 may also comprise an antenna 509 to facilitate remote communications with the control panel 501 for the purpose of manually starting a cycle of the system. The run button 517, may be electrically connected to a radio communications circuit which is in electrical communication with the antenna 509. In this way, the user, remote from the control panel 501, may signal the control panel 501 through the antenna 509 to activate the run button 517 to force a cycle of spraying. The communication circuit is not shown or elaborated on in more detail, as it is a very common circuit, well-known in the art and used for such applications as gate and garage door openers.

In an alternative embodiment, the control panel 501 may feature a communications port 519. The communications port 519 may be electrically connected to the timer and, specifically, the programmable circuits within the timer. If the timer utilizes flash ROM or other read-writeable storage technology, the inclusion of the communications port 519 may permit simplified updates to the programming of the timer circuits.

It will be appreciated that, although a unitary control panel 501 is described, the invention may function equally well by incorporating the functions of the control panel 501 into other components of the system. For example, the addition of a control circuit to the motor may achieve the effect of a separate control panel 501 and would, therefore, be considered a control panel pursuant to this specification. Similarly, the function of the control panel 501 could be accomplished remotely from the drum, as in via personal computer in communication with the pump and solenoid valve. Such a scenario, as well, would be considered a control panel under this disclosure, as it contains the same parts operating in the same way to accomplish the same result.

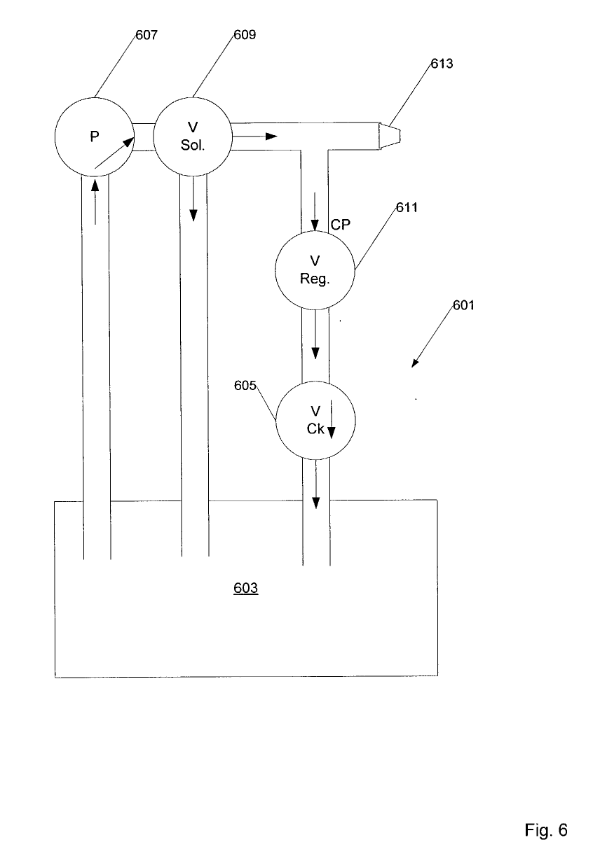

The fluid flow accomplished by the instant invention is shown with reference to FIG. 6. FIG. 6 shows the fluid flow 601 of the instant invention during normal operation. Insecticide is stored in a reservoir 603 such as the drum (101 in FIG. 1). Insecticide flows up to a pump 607. The output of the pump 607 leads to a solenoid valve 609. The solenoid valve 609, depending upon its state as open or closed, will or will not, respectively, permit flow of the insecticide of the nozzle 613. If the solenoid valve 609 is open, then the fluid flows toward the nozzle 613 and the constant pressure regulated valve 611. If the pressure created by pump 607 exceeds a regulated value, then insecticide flows down through a constant pressure regulated valve 611 and back into the reservoir 603 though a check valve 605. The check valve 605 disallows the flow of fluid from the reservoir 603 back up through the constant pressure regulated valve 611.

If the solenoid valve 609 is not permitting insecticide to flow up nozzle 613, the flow of the fluid is directed into the reservoir 603, causing agitation of the contents of the reservoir 603 so as to ensure that future insecticide heading to the pump 607 is mixed.

As to the specific manner of operation and use of the present invention, the same is made apparent from the foregoing discussion. However, for the sake of clarity, several key applications of the invention are highlighted. The foregoing invention includes applications in mosquito, gnat, no-see-ums, and other flying insect control. Similarly, the foregoing invention may be used to control flies or other disease carrying insects. Although the instant invention is designed for residential applications, those skilled in the art will well appreciate that it can be equally well applied to commercial, industrial and other locations.

With respect to the above description, it is to be realized that although embodiments of specific materials, valves, switches, representations, iterations, applications, flows and programming are disclosed, those enabling embodiments are illustrative in the currently-known optimum relationships for the parts of the invention. Accordingly, the invention may include variations in composition, forms, protocols, functions and manner of operation, each of which are deemed readily apparent to one's skill in the art in view of this disclosure. All relevant relationships to those illustrated in the drawings and the specifications are intended to be encompassed by the present invention and the appended claims.

Therefore, the foregoing is considered as illustrative of the principles of the invention. Numerous modifications will readily occur to those skilled in the art. It is not desired to limit the invention to the exact construction and operation shown or described, and all suitable modifications and equivalents may be resorted to, all falling within the scope of the invention and the claims.

What is claimed is:

1. An insect control apparatus comprising:
a reservoir containing insecticide;
a pump assembly situated so as to draw from the reservoir;
a nozzle in fluid communication with the pump assembly; and
a control panel in electrical communication with the pump assembly,
wherein the pump assembly is situated to discharge selectively into the reservoir or the nozzle, and
wherein the control panel is configured to cause the pump assembly to discharge into the reservoir immediately prior to the control panel causing the pump assembly to discharge to the nozzle.

2. The insect control apparatus of claim 1 further comprising a valve in fluid communication with the pump assembly, the nozzle, and the reservoir, wherein the position of the valve selects the discharge of the pump assembly to either the nozzle or the reservoir.

3. The insect control apparatus of claim 1 further comprising a valve, the valve in fluid communication with the pump assembly and the nozzle such that the valve being in a closed position limits the pump assembly discharge to the nozzle.

4. The insect control apparatus of claim 1 further comprising a valve, the valve in fluid communication with the pump assembly and the reservoir such that the valve being in a closed position limits the pump assembly discharge to the reservoir.

5. The insect control apparatus of claim 1 further comprising:
a constant pressure valve in fluid communication between the nozzle and the reservoir, and
a selector valve in fluid communication between the pump assembly and the nozzle,
wherein the constant pressure valve is operable to provide constant pressure between the pump assembly and the nozzle, and
wherein the selector valve is operable to selectively direct flow of fluid to the nozzle or the reservoir.

6. The insect control apparatus of claim 1 wherein the selector valve is a solenoid valve and in electric communication with the control panel.

7. The insect control apparatus of claim 1 wherein the control panel is programmable to select the discharge path of the pump assembly based upon the time of day.

8. The insect control apparatus of claim 2 wherein the control panel is programmable to select the discharge path of the pump assembly based upon the time of day.

9. The insect control apparatus of claim 3 wherein the control panel is programmable to select the discharge path of the pump assembly based upon the time of day.

10. The insect control apparatus of claim 1 wherein the selector valve is a solenoid valve and in electric communication with the control panel, and
wherein the control panel is programmable to select the discharge path of the pump assembly based upon the time of day.

11. A system for the creation of a mist from a liquid comprising:
a reservoir containing the liquid;
an intake conduit having a first end submerged within the reservoir and a second end;
a pump having an inlet in fluid communication with the second end of the intake conduit;
a valve having an inlet, a first output and a second output, the valve inlet in fluid communication with the output of the pump;
a recirculating conduit having a first end within the reservoir and having a second end in fluid communication with the first output of the valve; and
an atomizer in fluid communication with the second output of the valve.

12. The system of claim 11 further comprising a constant pressure valve in fluid communication between the first output of the valve and the pump,
wherein the constant pressure valve is configured so as to maintain a pressure on the valve when the pump is activated.

13. The system of claim 11 wherein the first end of the recirculating conduit comprises two outlets.

14. The system of claim 12 wherein the first end of the recirculating conduit comprises two outlets.

15. The system of claim 12 further comprising a timer assembly,
wherein the valve is an electrical solenoid valve, and
wherein the valve and the pump are in electrical communication with the timer assembly.

16. The system of claim 13 wherein the timer assembly further comprises:
an electrical input;
a switch in electrical connection to the electrical input, the switch having an off position,
a spray position and a recirculate position, the switch further having a pump output and a solenoid output; and
a timer operatively coupled to the switch,
wherein the switch selects between positions depending upon the timer,
wherein the switch is configured to connect the electrical input to the pump output and/or the solenoid output as appropriate in order to accomplish pumping through the atomizer or recirculating in to the reservoir.

17. A method of distributing insecticide to a fixed area comprising the steps of:
placing a pump in fluid connection to a reservoir of insecticide;
circulating the insecticide from the reservoir, using the pump, back to the reservoir; and
pumping the insecticide from the reservoir to the fixed area.

18. The method of claim 17 wherein the insecticide is a colloidal suspension when agitated.

19. The method of claim 17 wherein the step of pumping the insecticide comprises the steps of:
drawing the insecticide from the reservoir using the pump; and
forcing the insecticide through a plurality of aerators within the fixed area.

20. The method of claim 17 further comprising the steps of:
placing a timing circuit in control of the operation of the pump; and
configuring the timing circuit to periodically cause the circulating and pumping.

21. The method of claim 1 further comprising the steps of:
placing a timing circuit in control of the operation of the pump; and
configuring the timing circuit to periodically cause the circulating and pumping.
